(19) United States
(12) Patent Application Publication
(10) Pub. No.: US 2013/0286240 A1
(43) Pub. Date: Oct. 31, 2013

(54) IMAGE CAPTURING DEVICE AND OPERATING METHOD OF IMAGE CAPTURING DEVICE

(71) Applicant: SAMSUNG ELECTRONICS CO., LTD., Suwon-Si (KR)

(72) Inventors: Irina KIM, Suwon-si (KR); Nyeong-Kyu KWON, Daejeon (KR); HyeonSu PARK, Yongin-si (KR)

(73) Assignee: SAMSUNG ELECTRONICS CO., LTD., Suwon-Si (KR)

(21) Appl. No.: 13/790,035

(22) Filed: Mar. 8, 2013

(30) Foreign Application Priority Data
Apr. 30, 2012 (KR) 10-2012-0045716

(51) Int. Cl. H04N 5/225

(52) U.S. Cl. CPC H04N 5/225
USPC 348/222.1

(57) ABSTRACT

An operating method of an image capturing device includes capturing an image; detecting a target object from the captured image; calculating modification parameters based on the detected target object; generating an adjusted image by adjusting a size of an area of the captured image according to the modification parameters; and displaying the adjusted image.

### CROSS-REFERENCE TO RELATED APPLICATIONS

A claim for priority under 35 U.S.C §119 is made to Korean Patent Application No. 10-2012-0045716 filed Apr. 30, 2012, in the Korean Intellectual Property Office (KIPO), the entirety of which is incorporated by reference herein.

### BACKGROUND

The inventive concepts described herein relate to an image capturing device and an operating method thereof.

In recent years, the use of portable intelligence such as a smart phone, a smart pad, a notebook computer, and the lie may increase rapidly. The portable intelligence may have an image sensor such as a camera as information capturing means and a display unit for displaying images as information display means. As the portable intelligence including the image sensor and the display unit spreads, integration between the portable intelligence and a video conference system may have been researched. This may make it possible to realize an on-line office with mobility and real-time characteristic. With the on-line office, it is possible to have a conference anytime and anywhere.

The portable intelligence developed up to date may simply capture an image to store it. Research on intelligence supporting functions and services specialized to a video conference may be required to realize a video conference system using the portable intelligence.

### SUMMARY

One aspect of embodiments of the inventive concepts is directed to provide an operating method of an image capturing device which includes capturing an image; detecting a target object from the captured image; calculating modification parameters based on the detected target object; generating an adjusted image by adjusting a size of an area of the captured image according to the modification parameters; and displaying the adjusted image.

According to an example embodiment of the inventive concepts, the detecting a target object from the captured image includes detecting a location of the target object.

According to an example embodiment of the inventive concepts, the calculating modification parameters based on the detected target object includes calculating a first distance between the detected location of the target object and a first end of the captured image; calculating a second distance between the detected location of the target object and a second end of the captured image opposite to the first end; and calculating a third distance based on at least one of the first distance to the second distance.

According to an example embodiment of the inventive concepts, the third distance is calculated to have a reference ratio with respect to one, of the first and second distances.

According to an example embodiment of the inventive concepts, the calculating modification parameters based on the detected target object includes defining a resizing area of the captured image such that the detected target object is closer to a center of the resizing area, relative to a distance between the detected target object and a center of the captured image.

According to an example embodiment of the inventive concepts, the detecting a target object includes detecting a slope of the target object.

According to an example embodiment of the inventive concepts, the calculating modification parameters based on the detected target object includes defining a resizing area of the captured image such that a vertical alignment of the detected target object in the resizing area is increased, relative to a vertical alignment of the target object in the captured image.

According to an example embodiment of the inventive concepts, the adjusting a size of an area of the captured image according to the modification parameters scaling a size of a resizing area of the captured image by enlarging or reducing the size of the resizing area of the captured image such that the scaled size of the selected resizing area is equal to a size of the captured image.

According to an example embodiment of the inventive concepts, the target object is a face and an upper body.

According to an example embodiment of the inventive concepts, the operating method further includes adjusting intensity, saturation, or hue corresponding to a skin of the target object.

According to an example embodiment of the inventive concepts, the operating method further includes cancelling a noise, for example image noise, from an area corresponding to a skin of the target object.

According to an example embodiment of the inventive concepts, the operating method further includes smoothing boundaries of the target object and a background.

According to an example embodiment of the inventive concepts, the operating method further includes judging an atmosphere of the target object.

Another aspect of embodiments of the inventive concepts is directed to provide an image capturing device which includes an object detector configured to detect a target object from an image; a scaler configured to calculate modification parameters based on the detected target object, select a resizing area from the image according to the calculated modification parameters, and adjust a size of the image of the resizing area; and a digital image stabilizer which stabilizes the adjusted image.

According to an example embodiment of the inventive concepts, the image capturing device forms a smart phone, a smart tablet, a notebook computer, a smart television, a digital camera, or a digital camcorder.

According to an example embodiment, an operating method of an image capturing device may include capturing an image; detecting a target object within the captured image; determining a resizing area corresponding to the captured image by selecting parameters defining the resizing area such that, the resizing area includes the target object and, for the target object in the resizing area, at least one of a size and an angular orientation of the target object in changed, relative to the captured image; generating an adjusted image by adjusting the captured image based on the resizing area; and displaying the adjusted image.

According to an example embodiment of the inventive concepts, the determining includes identifying a reference point within the target object; calculating a first horizontal length between the reference point and a first edge of the captured image; calculating a second horizontal length between the reference point and a second edge of the captured image opposite to the first edge; calculating a third length based on at least one of the first distance and the second distance; and determining a horizontal length of the resizing area based on the third distance.

According to an example embodiment of the inventive concepts, the determining includes calculating parameters defining a resizing area of the captured image such that a vertical alignment of the detected target object with respect to an edge of the resizing area is increased, relative to a vertical alignment of the target object with respect to an edge of the captured image, the edge of the resizing area corresponding to the edge of the captured image.

### BRIEF DESCRIPTION OF THE FIGURES

The above and other features and advantages of example embodiments of the inventive concepts will become more apparent by describing in detail example embodiments with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIG. 1 is a block diagram schematically illustrating an image capturing device according to an embodiment of the inventive concepts.

FIG. 2 is a flowchart illustrating an operating method of an image capturing device according to an embodiment of the inventive concepts.

FIG. 3 is a diagram illustrating an example of a captured original image.

FIG. 4 is a diagram illustrating an example that a resizing area CR is set at an original image in FIG. 3.

FIG. 5 is a diagram illustrating a closed-up image.

FIG. 6 is a diagram illustrating another example that a resizing area is set.

FIG. 7 is a diagram illustrating still another example that a resizing area is set.

FIG. 8 is a diagram illustrating still another example that a resizing area is set.

FIG. 9 is a diagram illustrating a method of acquiring additional information of a target object in an image capturing device according to an embodiment of the inventive concepts.

FIG. 10 is a flowchart illustrating an operating method of an image capturing device 100 according to another embodiment of the inventive concepts.

FIG. 11 is a block diagram schematically illustrating an image capturing device according to another embodiment of the inventive concepts.

FIG. 12 is a block diagram schematically illustrating a multimedia device according to embodiments of the inventive concepts.

FIG. 13 is a conceptual diagram schematically illustrating a video conference system according to an embodiment of the inventive concepts.

### DETAILED DESCRIPTION

Embodiments of the inventive concepts are described more fully hereinafter with reference to the accompanying drawings, in which embodiments of the inventive concepts are shown. Example embodiments of the inventive concepts shown may, however, be embodied in many different forms and should not be construed as limited to the embodiments set forth herein. Rather, these embodiments are provided so that this disclosure will be thorough and complete, and will fully convey the scope of embodiments of the inventive concepts to those skilled in the art. In the drawings, the size and relative sizes of layers and regions may be exaggerated for clarity. Like numbers refer to like elements throughout.

Accordingly, while example embodiments of the inventive concepts are capable of various modifications and alternative forms, embodiments thereof are shown by way of example in the drawings and will herein be described in detail. It should be understood, however, that there is no intent to limit example embodiments of the inventive concepts to the particular forms disclosed, but to the contrary, example embodiments of the inventive concepts are to cover all modifications, equivalents, and alternatives falling within the scope of example embodiments of the inventive concepts. Like numbers refer to like elements throughout the description of the figures.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from embodiments of the inventive concepts.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of embodiments of the inventive concepts. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which embodiments of the inventive concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

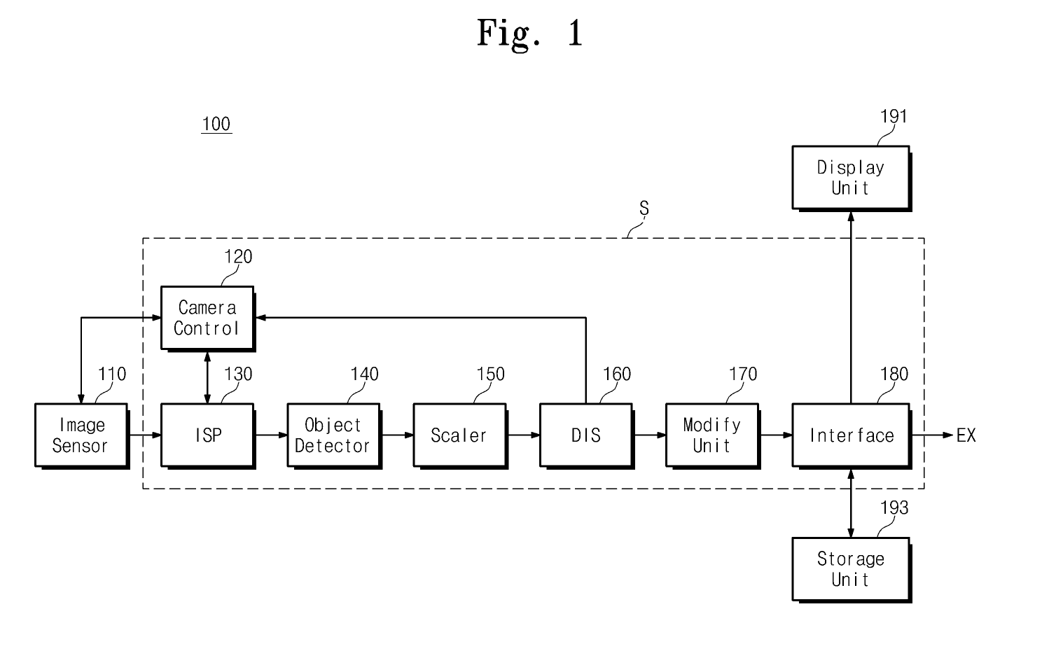

FIG. 1 is a block diagram schematically illustrating an image capturing device according to an embodiment of the inventive concepts. Referring to FIG. 1, an image capturing device 100 may include an image sensor 110, a camera control 120, an image signal processor (ISP) 130, an object detector 140, a scaler 150, a digital image stabilizer (DIS) 160, a modify unit 170, an interface 180, a display unit 191, and a storage unit 193.

The image sensor 110 may capture a target image. The image sensor 110 may include a plurality of image sensor pixels arranged in rows and columns. The image sensor 110 may include a charge coupled device (CCD) or a CMOS image sensor.

The camera control 120 may control the image sensor 110 in response to controls of the ISP 130 and the DIS 160. The camera control 120 may control auto exposure (AW), auto focus (AF), or auto white balance (AWB) of the image sensor 110.

The ISP 130 may process an image captured by the image sensor 110. For example, the ISP 130 may convert Bayer images captured by the image sensor 110 into RGB or YUV images.

The object detector 140 may detect a target object from an image processed by the ISP 130. The target object may be a face and an upper body of a human. The object detector 140 may detect a center point of the target object. The center point may detect the center of mass of the target image or a weight center of mass thereof (e.g., a center obtained by adding a weight to a face or an upper body).

The object detector 140 may select a resizing area of a processed image. For example, the object detector 140 may select the resizing area of the processed image in light of a size of the processed image, a location of a center point of the detected target object, and the like. The object detector 140 may select the resizing area where a location of the detected target object becomes close to the center. The object detector 140 may select the resizing area where the detected target object is placed vertically. An aspect ratio of the resizing area may be equal to that of an original image. The aspect ratio of the resizing area may be determined according to a reference, or alternatively, predetermined value. Information indicating the selected resizing area may be a modification parameter. The object detector 140 may output the processed image and the modification parameter to the scaler 150.

The scaler 150 may adjust a size of the resizing area based on the modification parameter. For example, the scaler 150 may adjust the size of the resizing area by enlarging or shrinking the resizing area. The scaler 150 may enlarge or shrink the resizing area such that the resizing area has the same size as an original image. The scaler 150 may enlarge or shrink the resizing area to have a predetermine size. The scaler 150 may output the processed image and the closed-up or closed-down image to the DIS 160.

The DIS 160 may stabilize a size-adjusted image or a size-adjusted image and the processed image. The DIS 160 may compensate instability such as hand-vibration by smoothing boundary lines of an object and a background. The DIS 160 may output a size-adjusted and stabilized image (a first stabilized image) or the first stabilized image and a processed and stabilized image (a second stabilized image) to the modify unit 170.

The modify unit 170 may receive and modify the first stabilized image or the second stabilized image. For example, the modify unit 170 may perform operations of adjusting a skin color of a target object and removing a noise, for example image noise. The modify unit 170 may output the modified image and the second stabilized image to the interface 180.

The modify unit 170 may perform skin compensation. For example, intensity, saturation, or hue of a region corresponding to a target object skin may be adjusted. The target object skin may brighten or whiten through adjusting of intensity, saturation, or hue. For example, a noise, for example image noise, may be canceled from a region corresponding to a target object skin. Blemish and freckle may be canceled from a region corresponding to a target object skin.

The interface 180 may be configured to communicate with an external device EX, the display unit 191, and the storage unit 193. The interface 180 may output the revised image, the second stabilized image, or the revised image and the second stabilized image via the display unit 191, store them at the storage unit 180, or output them to the external device EX. The interface 180 may store data (e.g., images) input from the external device EX at the storage unit 193 or output it to the display unit 191.

According to an example embodiment of the inventive concepts, the camera control 120, the ISP 130, the object detector 140, the scaler 150, the DIS 160, the modify unit 170, and the interface 180 may be integrated to form a system-on-chip.

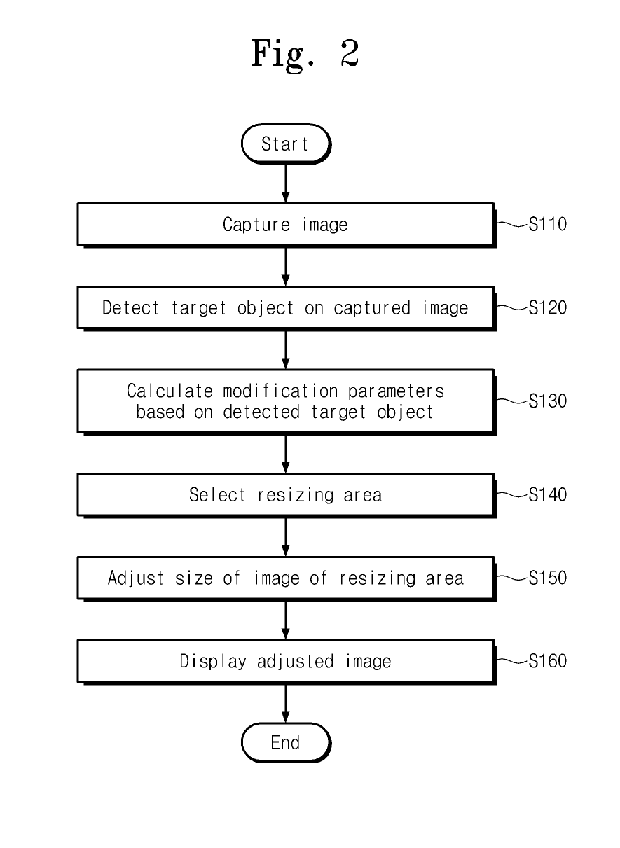

FIG. 2 is a flowchart illustrating an operating method of an image capturing device according to an embodiment of the inventive concepts. Referring to FIGS. 1 and 2, in operation S110, an image capturing device 100 may capture an image. The image capturing device 100 may capture a target image using an image sensor 110, and may process the captured image using an ISP 130.

In operation S120, the image capturing device 100 may detect a target object from the captured image. The image capturing device 100 may detect the target object from the captured image using an object detector 140. The image capturing device 100 may detect face and upper body of the human being the target object. However, example embodiments of the inventive concepts are not limited thereto.

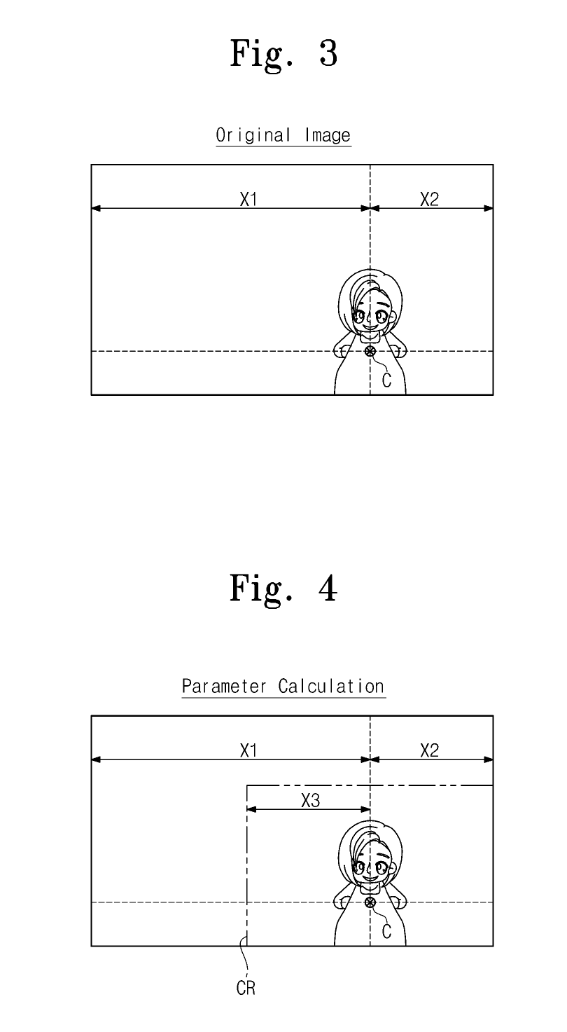

In operation S130, the image capturing device 100 may calculate modification parameters based on the detected target object. In operation S140, the image capturing device 100 may select a resizing area according to the modification parameters. In operation S150, the image capturing device 100 may resize an image corresponding to the resizing area. The operations S130 to S150 will be more fully described with reference to FIGS. 3 to 8.

In operation S160, the image capturing device 100 may display the resized resizing area (hereinafter, referred to as a resized image).

According to an example embodiment of the inventive concepts, the image capturing device 100 may store the captured image with the resized image. The image capturing device 100 may store the captured image with the modification parameters. When an image stored at the storage unit 193 is accessed, the image capturing device 100 may cut a part of the captured image according to the modification parameters stored at the storage unit 193, and may resize it.

FIG. 3 is a diagram illustrating an example of a captured original image. Referring to FIGS. 1 to 3, a target object may be detected from a captured original image. An object detector 140 may detect a center point C of a target object. The center point C may be a center of mass of the target object or a weighted center of mass. For example, a face of the target object may be weighted, or an upper body may be weighted. The object detector 140 may calculate a horizontal ratio of the center point C on the captured image. For example the center point C may have a horizontal ratio of X1:X2 on the captured image, the horizontal ratio of the center point C with respect to a given image being, for example, a ratio between a first and second lengths, where the first length is a horizontal length from a left side of the image to the center point C, and the second length is a horizontal length from a right side of the image to the center point C.

FIG. 4 is a diagram illustrating an example where a resizing area CR is set at an original image in FIG. 3. Referring to FIGS. 1 to 4, an object detector 140 may select a resizing area CR such that a center point C of a target object is placed at a center of the resizing area CR. The object detector 140 may select the resizing area CR such that a horizontal ratio of the center point C with respect to the resizing area CR is set to 1:1 or a reference, or alternatively, predetermined ratio. For example, the resizing area CR may be selected such that a horizontal ratio is set to X3:X2 on the basis of the center point C. According to an example embodiment of the inventive concepts, the selected resizing area CR is an example of a modification parameter. For example, the modification parameters may include boundary coordinate values or a horizontal ratio of the resizing area CR.

According to an example embodiment of the inventive concepts, an aspect ratio of the resizing area CR may be selected to be equal to that of the captured original image. The aspect ratio of the resizing area CR may be selected according to a reference, or alternatively, predetermined value.

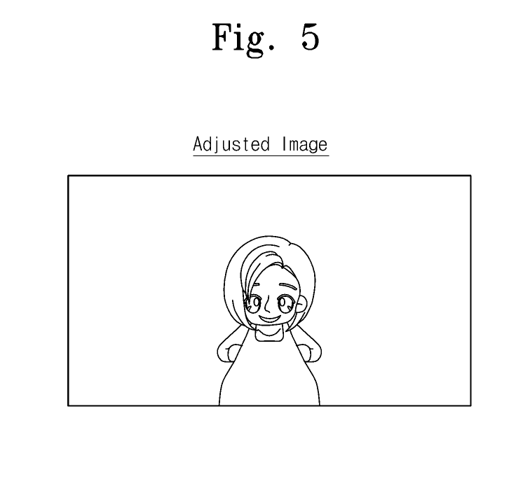

The scaler 150 may modify a size of the resizing area CR according to the modification parameters. The scaler 150 may enlarge the resizing area CR as illustrated in FIG. 5.

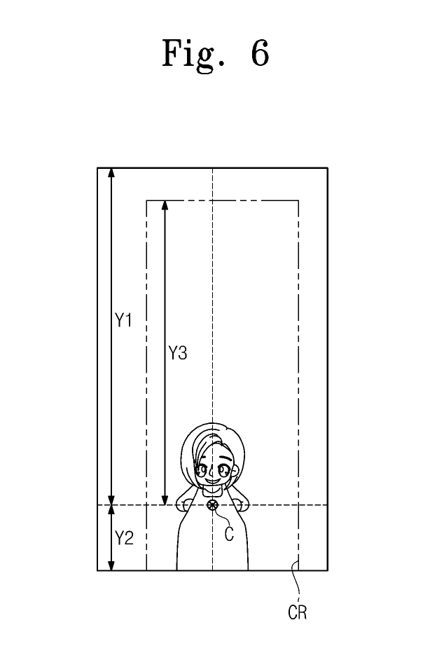

FIG. 6 is a diagram illustrating another example where a resizing area is set. Referring to FIGS. 1, 2, and 6, an object detector 140 may select a resizing area CR such that a center point C of a target object is placed at a center. The object detector 140 may select the resizing area such that a vertical ratio of the center point C is set to 1:1 or a reference, or alternatively, predetermined ratio. For example, a vertical ratio of the center point C may be Y1:Y2 at the captured original image and a vertical ratio of the center point C may be Y3:Y2 at the resizing area CR. For example, the vertical ratio of the center point C with respect to a given image being, for example, a ratio between a first and second lengths, where the first length is a vertical length from a top side of the image to the center point C, and the second length is a vertical length from a bottom side of the image to the center point C. According to an example embodiment of the inventive concepts, the resizing area CR is an example of a modification parameter. For example, the modification parameters may include boundary coordinate values or a vertical ratio of the resizing area CR.

In an example embodiment of the inventive concepts, an aspect ratio of the resizing area CR may be selected to be equal to that of the captured original image. The aspect ratio of the resizing area CR may be selected according to a reference, or alternatively, predetermined value.

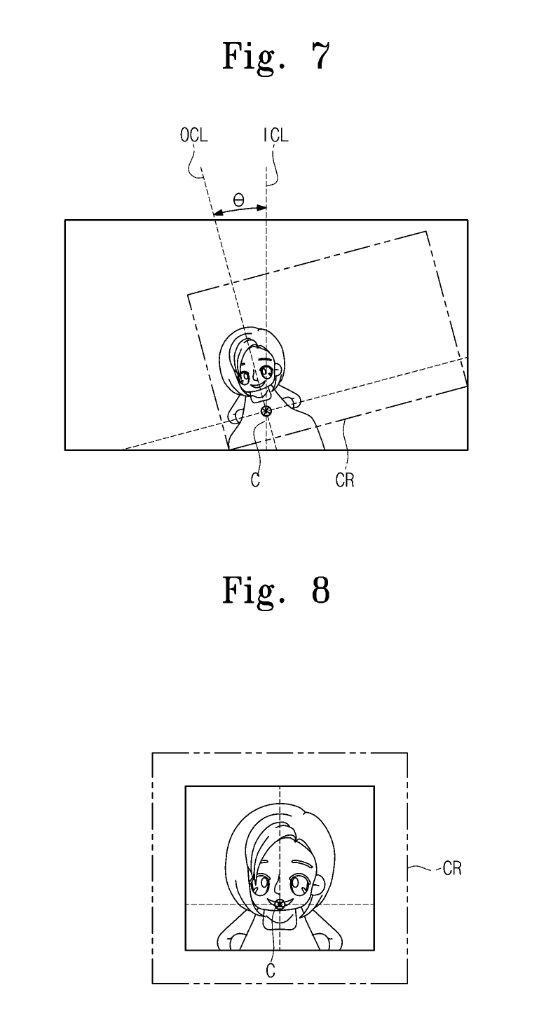

FIG. 7 is a diagram illustrating still another example where a resizing area is set. Referring to FIGS. 1, 2, and 7, an object detector 140 may select a resizing area CR such that a target object becomes vertical at a resizing area CR. For example, the resizing area CR may be selected so as to pass through a center point C of the target object and such that a vertical line OCL is perpendicular to a horizontal line of the resizing area CR, where the vertical line OCL may be, for example a line that penetrates, or passes through, points located at both the face and upper body of the target object, and the horizontal line of the resizing area CR may be, for example, a line parallel to an upper (top) or lower (bottom) edge of the resizing area CR. For example, the selected resizing area CR may be modification parameters. For example, the modification parameters may include boundary coordinate values of the resizing area CR or an angle θ between a vertical line ICL of a captured original image and a vertical line OCL of the target object, where the vertical line ICL of the original image may be, for example a line parallel to a left or right edge of the original image.

According to an example embodiment of the inventive concepts, an aspect ratio of the resizing area CR may be selected to be equal to that of the captured original image. The aspect ratio of the resizing area CR may be selected according to a reference, or alternatively, predetermined value.

According to an example embodiment of the inventive concepts, the resizing area CR may be selected through combination of methods described with reference to FIGS. 4 to 7. The resizing area CR may be selected in light of a horizontal ratio of the center point C and a slope of the vertical target object.

According to an example embodiment of the inventive concepts, the resizing area CR may be selected through combination of methods described with reference to FIGS. 6 and 7. The resizing area CR may be selected in light of a vertical ratio of the center point C and a slope of the target object, where the slope of the target object may be a slope of the vertical line OCL of the target object relative to the vertical line ICL of the original image.

According to an example embodiment of the inventive concepts, the resizing area CR may be selected through combination of methods described with reference to FIGS. 4 and 6. The resizing area CR may be selected in light of horizontal and vertical ratios of the center point C.

According to an example embodiment of the inventive concepts, the resizing area CR may be selected through combination of methods described with reference to FIGS. 4, 6, and 7. The resizing area CR may be selected in light of horizontal and vertical ratios of the center point C and a slope of the target object.

FIG. 8 is a diagram illustrating still another example that a resizing area is set. Referring to FIGS. 1, 2, and 8, an object detector 140 may select an aspect ratio of a resizing area CR such that a ratio of a size of a target object to a size of the resizing area CR is below a specific value. For example, if an aspect ratio of the target object is larger than the reference value at an original image, the resizing area CR may be set to be larger than the original image. The resizing area CR may be reduced in size. That is, the object detector 140 may reduce the size of the original image.

According to an example embodiment of the inventive concepts, the resizing area CR may be determined based on a ratio between a size of the target object and a size of the original image, and a size of the target object. For example, the resizing area CR may be determined such that a size of a face of the target object is included within a specific range. In the event that a face of the target object is captured to be larger than a first threshold value, the resizing area CR may be selected such that the target object is reduced in size. In the event that a face of the target object is captured to be smaller than a second threshold value, the resizing area CR may be selected such that the target object is enlarged.

As described above, an image capturing device 100 according to an embodiment of the inventive concepts may process and display an image such that a target object is displayed using an optimized ratio and at an optimized location. An improved quality of service may be provided at a circumstance, in which an image is used, such as video conference.

With embodiments of the inventive concepts, face and upper body of a target object may be detected. Since both the face with relatively much motion and the upper body with relatively less motion are detected, the target object may be detected stably. For example, in the event that a target object inclines a face in one direction, the resizing area CR may maintain an inclined face without tracking.

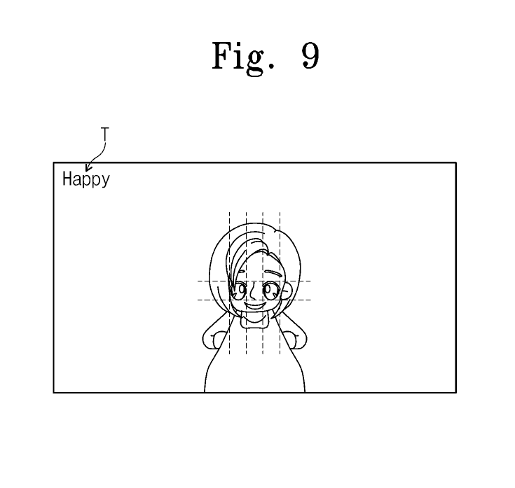

FIG. 9 is a diagram illustrating a method of acquiring additional information of a target object in an image capturing device according to an embodiment of the inventive concepts. Referring to FIGS. 1 and 9, an object detector 140 may detect an atmosphere of a target object. The object detector 140 may detect an atmosphere of the target object in light of an eye size, motion of eyes, a blinking number, an eye shape, a mouth shape, motion of mouth, a pose, and the like associated with the target object. An original image, a closed-up image, or a copied image of the original image or the closed-up image may be edited according to an atmosphere of the detected target object. For example, a text T indicating the detected atmosphere of the target object may be added. There may be added emoticon, background, and the like indicating the detected atmosphere of the target object. Hue may be adjusted according to the detected atmosphere of the target object. The detected atmosphere may be, for example, a detected mood or disposition of the target object.

For example, additional information indicating the detected atmosphere of the target object may be stored at a storage unit 193 with an original image or a closed-up image. The additional information may be used to classify an original image or a closed-up image.

According to an example embodiment of the inventive concepts, activation and inactivation of an automatic editing function may be adjusted by a user. For example, automatic position editing may be controlled. If the automatic position editing is activated, an operation described with reference to FIGS. 2 to 7 will be performed. An image capturing device 100 may display the original image via a display unit 191 or store it at the storage unit 193. The image capturing device 100 may display the adjusted image via the display unit 191 or store it at the storage unit 193. The image capturing device 100 may calculate modification parameters to store it at the storage unit 193.

For example, automatic atmosphere detection may be controlled. If the automatic atmosphere detection is activated, the image capturing device 100 may display the original image via the display unit 191 or store it at the storage unit 193. The image capturing device 100 may display a copied image displaying atmosphere information via the display unit 191 or store it at the storage unit 193. The image capturing device 100 may store atmosphere information at the storage unit 193.

For example, automatic modification may be controlled. If the automatic modification is activated, the image capturing device 100 may display the original image via the display unit 191 or store it at the storage unit 193. The image capturing device 100 may display a stabilized copied image via the display unit 191 or store it at the storage unit 193. If two or more functions are activated, the image capturing device 100 may display the original image or copied image experiencing two or more functions via the display unit 191 or store it at the storage unit 193.

According to an example embodiment of the inventive concepts, combination of the original image and an adjusted copied image may be displayed via the display unit 191. A first region of the display unit 191 may display the original image, and a second region thereof may display the adjusted copied image.

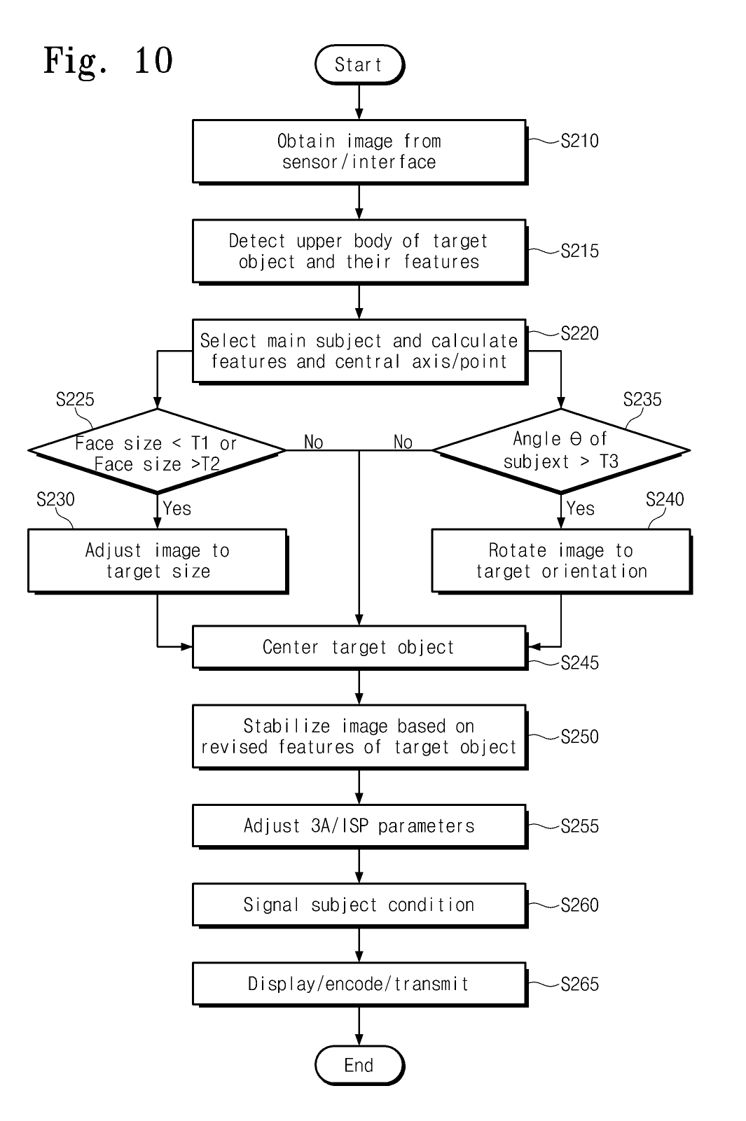

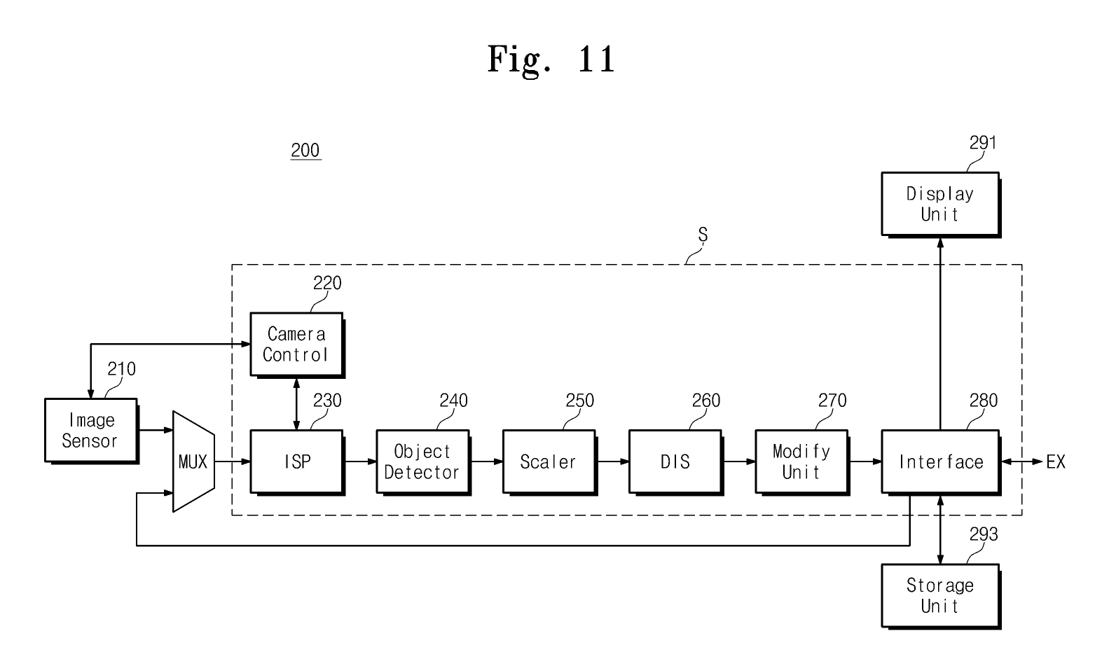

FIG. 10 is a flowchart illustrating an operating method of an image capturing device 100 according to another embodiment of the inventive concepts. Referring to FIGS. 1 and 10, in operation S210, an image may be captured from an image sensor 110 or an interface 180.

In operation S215, upper body and feature of a target object may be detected from the captured image. For example, an object detector 140 may detect the upper body including a face of the target object from the captured image. The object detector 140 may detect at least one of a skin of the target object, intensity, saturation, or hue associated with the skin of the target object, a noise, for example image noise, and a boundary between the target object and a background.

In operation S220, a main subject may be selected, and features and a central axis or point of the selected main subject may be calculated. For example, when a plurality of object subjects exist at the captured image, the object detector 140 may select a main subject of the plurality of object subjects. The main subject may be an object subject placed at the center, the largest captured object subject, or an object subject equal to previously stored data. The object detector 140 may detect at least one of a size of the selected main subject, a skin of the main subject, intensity, saturation, or hue associated with the skin of the main subject, a noise, for example image noise, and a boundary between the main subject and a background.

Afterwards, operations S225 and S230 may be performed in parallel with operations S235 and S240.

In operation S225, whether a face size of the main subject is smaller than a first threshold value T1 or larger than a second threshold value T2 may be judged. If the face size is smaller than the first threshold value T1 or larger than the second threshold value T2, in operation S230, an image size may be adjusted.

In operation S235, whether an inclined angle θ of the object subject is larger than a third threshold value T3 may be judged. The object detector 140 may compare the inclined angle θ of the object subject with the third threshold value T3. If the inclined angle θ of the object subject is larger than the third threshold value T3, in operation S240, the captured image may be rotated.

In operation S245, an image may be adjusted such that the target object is placed at a center.

According to an example embodiment of the inventive concepts, image adjustment executed in operations S225, S230, and S245 may be performed according to a method described with reference to FIGS. 3 to 6. A modification parameter may be calculated according to a feature of the target object, and an image may be adjusted according to the modification parameter.

Operations S235, S240, and S245 may be performed according to a method described with reference to FIG. 7. A modification parameter may be calculated according to a feature of the target object, and an image may be adjusted according to the modification parameter.

In operation S250, an image may be stabilized according to a feature of the target object. For example, smoothing may be performed by a DIS 160. A modify unit 170 may perform operations of adjusting a skin color of the target object and cancelling a noise, for example image noise.

In operation S255, auto exposure (AW), auto focus (AF), or auto white balance (AWB) of the image sensor 110 may be adjusted according to the adjustment result of the captured image. Parameters of the ISP 130 may be adjusted according to the adjustment result of the captured image.

In operation S260, a state of the target object may be displayed. As described with reference to FIG. 9, an atmosphere of the target object may be detected, and the detected atmosphere may be displayed at an image.

In operation S265, an adjusted image, an original image, or the adjusted image and original image may be displayed via the display unit 191, may be stored at the storage unit 193 through encoding, or may be output to an external device EX.

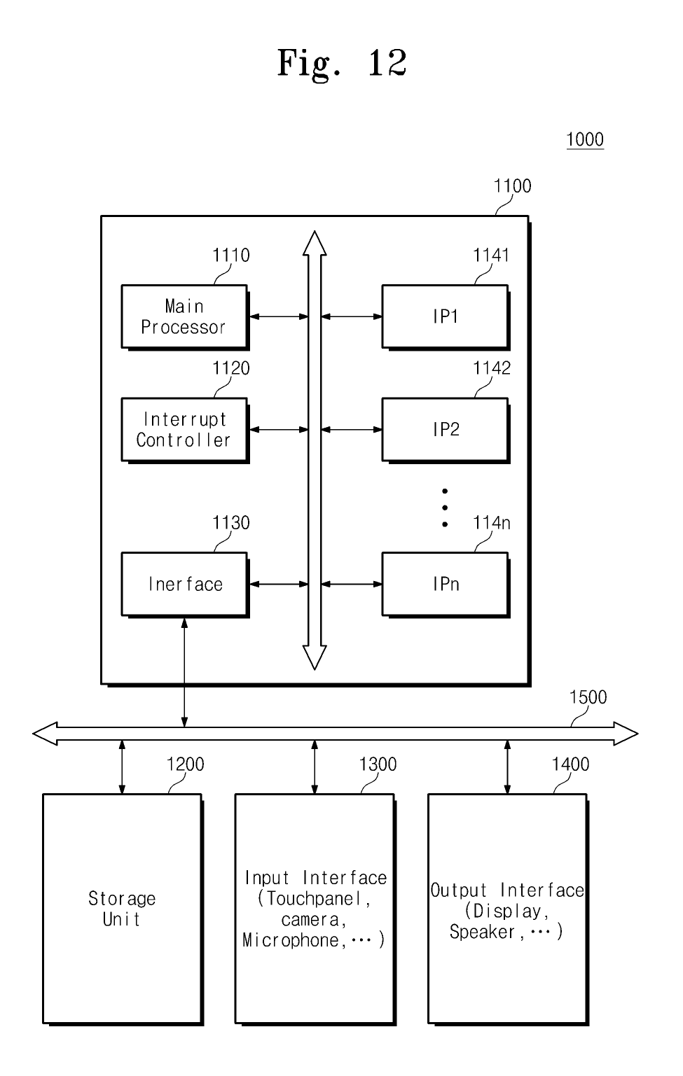

FIG. 11 is a block diagram schematically illustrating an image capturing device according to another embodiment of the inventive concepts. Referring to FIG. 11, an image capturing device 200 may include an image sensor 210, a camera control 220, an image signal processor (ISP) 230, an object detector 240, a scaler 250, a digital image stabilizer (DIS) 260, a modify unit 270, an interface 280, a display unit 291, a storage unit 293, and a multiplexer MUX.

Compared with an image capturing device 100 in FIG. 1, the image capturing device 200 in FIG. 11 may further include the multiplexer MUX. The multiplexer MUX may select one of an output signal of the image sensor 210 and an output signal of the interface 280 to output it to the ISP 230.

For example, when an image captured by the image sensor 210 is processed, the multiplexer MUX may output an output signal of the image sensor 210 to the ISP 230. When an image input via the interface 280 is processed, the multiplexer MUX may output an output signal of the interface 280 to the ISP 230. For example, an image signal read from the storage unit 293 or an image input from an external device EX may be transferred to the multiplexer MUX via the interface 280.

That is, an image signal transferred form the external device EX or an image stored at the storage unit 293 may be also processed to an optimized image through automatic editing.

According to an example embodiment of the inventive concepts, the camera control 220, the ISP 230, the object detector 240, the scaler 250, the DIS 260, the modify unit 270, and the interface 280 may be integrated to form a system-on-chip.

As described above, a captured image may be automatically edited according to a location or a slope of a target object of the captured image. Also, the captured image may be automatically edited by operations such as skin modification, stabilization, atmosphere detection, and the like. Thus, since an optimized image is acquired without additional operations of a user, it is possible to provide an image capturing device with an improved convenience and its operating method.

Embodiments of the inventive concepts may be described using an example that a captured image is edited. However, example embodiments of the inventive concepts are not limited thereto. For example, an image sensor 210 may be controlled according to a detection result of an object detector 140/240. Zoom-in or zoom-out, a capture direction, and a rotation of the image sensor 210 may be controlled according to a detection result of an object detector 140/240.

FIG. 12 is a block diagram schematically illustrating a multimedia device according to an embodiment of the inventive concepts. Referring to FIG. 12, a multimedia device 1000 may include an application processor 1100, a storage unit 1200, an input interface 1300, an output interface 1400, and a bus 1500.

The application processor 1100 may be configured to control an overall operation of the multimedia device 1000. The application processor 1100 may be formed of a system-on-chip.

The application processor 1100 may include a main processor 1110, an interrupt controller 1120, an interface 1130, a plurality of intelligent property (IP) blocks 1141 to 114n, and an internal bus 1150.

The main processor 1110 may be a core of the application processor 1100. The interrupt controller 1120 may manage interrupts generated within the application processor 1100 to report it to the main processor 1110.

The interface 1130 may relay communications between the application processor 1100 and external elements. The interface 1130 may relay communications such that the application processor 1100 controls external elements. The interface 1130 may include an interface for controlling the storage unit 1200, an interface for controlling the input and output interfaces 1300 and 1400, and the like. The interface 1130 may include JTAG (Joint Test Action Group) interface, TIC (Test Interface Controller) interface, memory interface, IDE (Integrated Drive Electronics) interface, USB (Universal Serial Bus) interface, SPI (Serial Peripheral Interface), audio interface, video interface, and the like.

The IP blocks 1141 to 114n may be performed specific functions, respectively. For example, the IP blocks 1141 to 114n may include an internal memory, a graphic processing unit (GPU), a modem, a sound controller, a security module, and the like.

The internal bus 1150 may provide a channel among internal elements of the application processor 1100. For example, the internal bus 1150 may include an AMBA (Advanced Microcontroller Bus Architecture) bus. The internal bus 1150 may include AMBA AHB (Advanced High Performance Bus) or AMBA APB (Advanced Peripheral Bus).

According to an example embodiment of the inventive concepts, at least one of a camera control 120/220, an ISP 130/230, an object detector 140/240, a scaler 150/250, a DIS 160/260, a modify unit 170/270 in FIG. 1 or 10 may be realized on at least one of the main processor 1110 and the IP blocks 1141 to 114n of the application processor 1100.

According to an example embodiment of the inventive concepts, at least one of a camera control 120/220, an ISP 130/230, an object detector 140/240, a scaler 150/250, a DIS 160/260, a modify unit 170/270 in FIG. 1/10 may be realized by software which is driven by at least one of the main processor 1110 and the IP blocks 1141 to 114n of the application processor 1100.

An interface 180/280 in FIG. 1/10 may correspond to an interface 1130 of the application processor 1100.

The storage unit 1200 may be configured to communicate with other elements of the multimedia device 1000 via the bus 1500. The storage unit 1200 may store data processed by the application processor 1100. The storage unit 1200 may correspond to a storage unit 193/293 described with reference to FIG. 1/10.

The input interface 1300 may include various devices for receiving signals from an external device. The input interface 1300 may include a keyboard, a key pad, a button, a touch panel, a touch screen, a touch ball, a touch pad, a camera including an image sensor, a microphone, a gyroscope sensor, a vibration sensor, a data port for wire input, an antenna for wireless input, and the like. The input interface 1300 may correspond to an image sensor 110/210 described with reference to FIG. 1/10.

The output interface 1400 may include various devices for outputting signal to an external device. The output interface 1400 may include an LCD, an OLED (Organic Light Emitting Diode) display device, an AMOLED (Active Matrix OLED) display device, an LED, a speaker, a motor, a data port for wire output, an antenna for wireless output, and the like. The output interface 1400 may correspond to a display unit 191/291 described with reference to FIG. 1/10.

The multimedia device 1000 may automatically edit an image captured via an image sensor to display it via a display unit of the output interface 1400. The multimedia device 1000 may provide a video conference service specialized for video conference and having an improved quality of service.

The multimedia device 1000 may include a mobile multimedia device such as a smart phone, a smart pad, and the like or a non-portable multimedia device such as a smart television and the like.

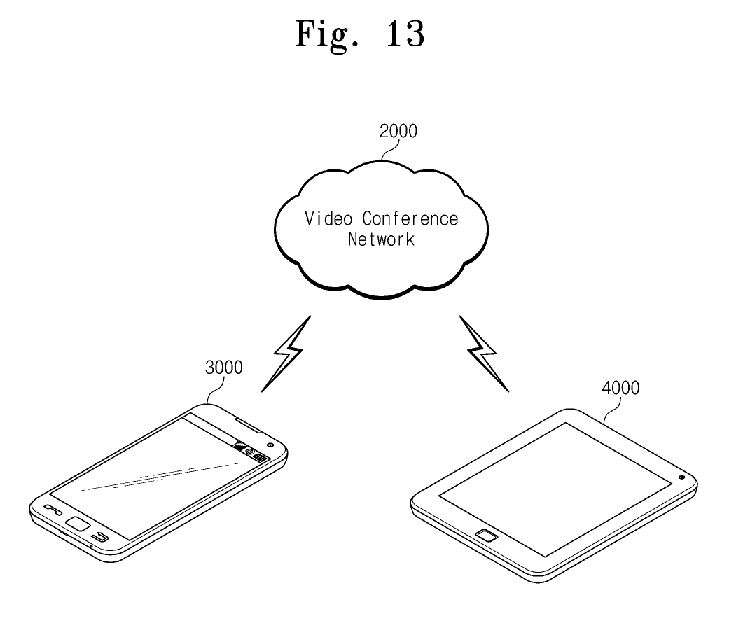

FIG. 13 is a conceptual diagram schematically illustrating a video conference system according to an embodiment of the inventive concepts. Referring to FIG. 13, a video conference system may include a video conference network 2000 and image capturing devices 3000 and 4000.

The video conference network 2000 may perform wire or wireless communication with the image capturing devices 3000 and 4000. The video conference network 2000 may provide a video communication service to the image capturing devices 3000 and 4000. A servicer may include a share, a router, a gateway, a switch, a packet switch, and the like.

Each of the image capturing devices 3000 and 4000 may include an image capturing device 100 or 200 described with reference to FIG. 1 or 11. The image capturing devices 3000 and 4000 may automatically edit a captured image such that a target object is displayed by an optimized ratio and at an optimized location. The image capturing devices 3000 and 4000 may include a smart phone, a smart pad, a notebook computer, a desktop computer, a smart television, and the like.

The video conference system according to an embodiment of the inventive concepts may automatically edit a target object performing video conference so as to be displayed by an optimized ratio and at an optimized location. Thus, it is possible to provide a video conference system having an improved quality of service.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description. Example embodiments of the inventive concepts having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. An operating method of an image capturing device, comprising:
capturing an image;
detecting a target object from the captured image;
calculating modification parameters based on the detected target object;
generating an adjusted image by adjusting a size of an area of the captured image according to the modification parameters; and
displaying the adjusted image.

2. The operating method of claim 1, wherein the detecting comprises:
detecting a location of the target object.

3. The operating method of claim 2, wherein the calculating comprises:
calculating a first distance between the detected location of the target object and a first end of the captured image;
calculating a second distance between the detected location of the target object and a second end of the captured image opposite to the first end; and
calculating a third distance based on at least one of the first distance to the second distanced.

4. The operating method of claim 3, wherein the third distance is calculated to have a reference ratio with respect to one of the first and second distances.

5. The operating method of claim 2, wherein the calculating comprises:
calculating parameters defining a resizing area of the captured image such that the detected target object is closer to a center of the resizing area, relative to a distance between the detected target object and a center of the captured image.

6. The operating method of claim 1, wherein the detecting comprises:
detecting a slope of the target object.

7. The operating method of claim 6, wherein the calculating comprises:
calculating parameters defining a resizing area of the captured image such that a vertical alignment of the detected target object in the resizing area is increased, relative to a vertical alignment of the target object in the captured image.

8. The operating method of claim 1, wherein the adjusting comprises:
scaling a size of a resizing area of the captured image by enlarging or reducing the size of the resizing area of the captured image such that the scaled size of the selected resizing area is equal to a size of the captured image.

9. The operating method of claim 1, wherein the target object includes a face and an upper body.

10. The operating method of claim 9, further comprising:
adjusting intensity, saturation, or hue corresponding to a skin of the target object.

11. The operating method of claim 9, further comprising:
cancelling image noise from an area corresponding to a skin of the target object.

12. The operating method of claim 9, further comprising:
smoothing boundaries of the target object and a background of the target object.

13. The operating method of claim 1, further comprising:
judging an atmosphere of the target object.

14. An image capturing device, comprising:
an object detector configured to detect a target object from an image;
a scaler configured to calculate modification parameters based on the detected target object, select a resizing area from the image according to the calculated modification parameters, and adjust a size of the resizing area; and
a digital image stabilizer configured to stabilize the adjusted image.

15. The image capturing device of claim 14, wherein the image capturing device forms a smart phone, a smart tablet, a notebook computer, a smart television, a digital camera, or a digital camcorder.

16. An operating method of an image capturing device, comprising:
capturing an image;
detecting a target object within the captured image;
determining a resizing area corresponding to the captured image by selecting parameters defining the resizing area such that, the resizing area includes the target object and, for the target object in the resizing area, at least one of a size and an angular orientation of the target object in changed, relative to the captured image;
generating an adjusted image by adjusting the captured image based on the resizing area; and
displaying the adjusted image.

17. The operating method of claim 16, wherein determining comprises:
identifying a reference point within the target object;
calculating a first horizontal length between the reference point and a first edge of the captured image;
calculating a second horizontal length between the reference point and a second edge of the captured image opposite to the first edge;
calculating a third length based on at least one of the first distance and the second distance; and
determining a horizontal length of the resizing area based on the third distance.

18. The operating method of claim 16, wherein the determining comprises:
calculating parameters defining a resizing area of the captured image such that a vertical alignment of the detected target object with respect to an edge of the resizing area is increased, relative to a vertical alignment of the target object with respect to an edge of the captured image, the edge of the resizing area corresponding to the edge of the captured image.
